(19) United States
(12) Patent Application Publication
(10) Pub. No.: US 2003/0051213 A1
(43) Pub. Date: Mar. 13, 2003

(54) Document passing system, document updating controller, client device, document management server, method of controlling updating of document, recording medium and program

(76) Inventor: Hidetsugu Mitsui, Chigasaki-shi (JP)

Correspondence Address: Morrison & Foerster LLP, Suite 300, 1650 Tysons Boulevard, McLean, VA, 22102, US

(21) Appl. No.: 10/235,653

(22) Filed: Sep. 6, 2002

(30) Foreign Application Priority Data
Sep. 7, 2001 (JP) 2001-271854

(51) Int. Cl. G06F 15/00

(52) U.S. Cl. 715/511; 715/530

(57) ABSTRACT

In a case where there is a request for inputting a decision result regarding a predetermined matter described on a document retrieved from a server, it is determined whether there is a priority process for inputting an approval result regarding the document. In the case where it is determined that there is no priority process to be executed, information representing that the approval result can be input and representing the contents of the approval result is sent to the server. On the contrary, in the case where it is determined that there is the priority process to be executed, information representing that the approval result can not be input is sent to the server.

### BACKGROUND OF THE INVENTION

1. Field of the Invention

The present invention relates to a document passing system for controlling an updating process for updating a predetermined document based on a decision made by a user over a predetermined matter described on the document.

2. Description of the Related Art

In recent years, it is common to practically use a document passing system (groupware) for controlling an updating process for updating a predetermined document based on a decision made over a predetermined matter, with an information technology using a client-server system. In such a document passing system in a company, a user (a staff of a company) forms a digitized document using a client device, sends the formed document to a server device, and stores the document in a database of the server device. Then, another user (e.g., the boss of the staff) accesses the document using a client device, and carries out an approving (decision making) process for stamping, examining, approving, attaching a comment, etc. on the document. In such a document passing system, the boss accesses the database using the client device, views the document formed by the staff, and approves the viewed document, thereby assisting the viewer in updating the document in based on a decision over a predetermined matter described on the document, In the document passing system, the staff having formed the document can access the database, and view the document after approved, as well.

In such a conventional document passing system, a problem is that a plurality of users are in contention for updating the document in the approving process, when the document is passed among a plurality of users. For example, a predetermined document may be passed among a plurality of bosses of the staff, so as to be approved by them. In this case, the plurality of bosses may access the document at the same time. In this case, no problem occurs even if one boss accesses the document, after another boss has completed the approving process for updating the document. However, a problem occurs if one boss updates the document while another boss is updating the document, in the case where the same document is accessed by the plurality of bosses at the same time. In this case, the document, which is updated first in the approving process by one boss, can not be stored, while being updated by another boss.

Exclusive control of the document may be operated, while the same document is accessed by a plurality of users at the same time, so that a user is prohibited from updating the document while another user has already begun updating the document In typical conventional groupware, in the case where an updating request which should be denied is transmitted, the client device displays a message “A copy of the document being updated is stored. Do you want to save it as a “contention document” that users are in contention for updating?”. After this, the updating request is rejected. In this case, in response to a question “Do you want to save it?”, if the user selects the answer “Yes”, the client device stores the document that the users are in contention for updating, as the “contention document”. Only when the document can be updated, the user can execute a process for updating the document.

In the conventional document passing system, the above-described approving process is performed for a predetermined document, and a request for updating the document is sent to the server. Upon this, the server determines whether the document is the contention document that the users are in contention for updating, and sends a message representing the determination result to the client device. In this structure, even if the user inputs predetermined information to update the document, as long as the server does not accept the request for updating the document, the user needs to store the document as the “contention document” or to loose the input result without saving it as the “contention document”. Even if the document is saved as the “contention document”, an additional process is necessary in order to use the document at the point the user can update the document. For the above reasons, the conventional document passing system can not easily or conveniently be operated.

### SUMMARY OF THE INVENTION

The present invention has been made in consideration of the above. It is accordingly an object of the present invention to provide a technique for informing early one or more users that they are in contention for updating the same document, in a case where the document is being accessed by the plurality of users at the same time.

Another object thereof is to provide a technique for preventing a plurality of users from being in contention for updating the same document, so that unnecessary inputting operations are not required.

In order to accomplish the above objects, according to the first aspect of the present invention, there is provided a document updating controller comprising:

an acquirer which acquires digitized document data in a form of a document describing a predetermined matter over which each of a plurality of users makes a decision, from a server;

a memory unit which stores the acquired document data;

a display unit which displays the stored document data;

an input unit which accepts a request for inputting a decision result regarding the predetermined matter, from one of the plurality of users;

a determiner which determines whether there is a priority process, having priority over any other processes, for inputting the decision result produced by another one of the plurality of users, upon detection of the request from the one of the plurality of users;

a sender which sends information representing that the decision result can be input and representing contents of the decision result, in a case where it is determined that there is no priority process; and

an informer which informs the one of the plurality of users that the decision result can not be input, in a case where it is determined that there is the priority process.

According to the structure of the controller of the present invention, the controller can send information representing that the decision result can not be input to the users, thereby preventing the plurality of users from being in contention for updating the document and unnecessary inputting operations.

The determiner may determine whether there is the priority process to be executed, by inquiring of the server whether there is the priority process to be executed.

According to this structure of the device, the controller can acquire information representing whether there is a priority process to be executed from the server.

The status information may include information regarding an editor of the document.

According to this structure of the controller, one of the users can receive status information representing that the decision result regarding the document is input by another user, from the server. Upon reception of such status information from the server, the one of the users can determine that there is a priority process to be executed.

The status information includes information regarding an editor of the document.

According to this structure of the controller, the controller can acquire information representing an editor of the document, e.g. information representing a user currently editing the document, thereby easily determining whether there is a priority process to be executed.

The determiner may determine that there is the priority process, in a case where the determiner receives status information representing that the decision result has been input within a predetermined period of time, from the server.

According to the structure of the controller, one of the plurality of users can acquire the status information representing that the decision result regarding the document is input by another one of the users, from the server. Upon reception of such status information, the one of the plurality of users can easily determine that there is a priority process to be executed.

The status information may include date information representing an updating date the document is updated; and

the determiner may determine that there is the priority process to be executed, in a case where the updating date is not same as a calling date the document is called from the server.

According to the structure of the controller, the server may be configured to execute a process for storing the updating date the document is updated, so that the device can acquire the updating date from the server. The controller stores the calling date, in the memory unit, so as to understand the calling date the document is called. In this case, if the calling date is not the same as the updating date, it is obvious that the decision result has been input by another user, thereby easily determining whether there is a priority process to be executed.

The acquirer may acquire data regarding the priority process, together with the document data;

the memory unit may store the data regarding the priority process in association with the document data; and

the determiner may refer to the data regarding the priority process and stored in the memory unit, and determine whether there is the priority process to be executed.

According to this structure of the controller, the controller refers to the stored information in the memory unit, to acquire information representing whether there is a priority process to be executed.

In order to accomplish the above objects, according to the second aspect of the present invention, there is provided a client device comprising:

an acquirer which acquires digitized document data in a form of a document describing a predetermined matter over which each of a plurality of users makes a decision, from a server;

a memory unit which stores the acquired document data;

a display unit which displays the stored document data;

an input unit which accepts a request for inputting a decision result regarding the predetermined matter, from one of the plurality of users;

a determiner which determines whether another one of the plurality of users is editing the document data, upon detection of the request from the one of the plurality of users;

a sender which sends information representing that the decision result can be input and representing contents of the decision result, in a case where it is determined the another one of the plurality of users is not editing the document data; and

an informer which informs the one of the plurality of users that the decision result can not be input, in a case where it is determined that the another one of the plurality of users is editing the document data.

According to this structure of the controller, the controller sends information representing that the decision result can not be input to each of the users, thereby preventing the plurality of users from being in contention for updating the document and unnecessary inputting operations.

In order to accomplish the above objects, according to the third aspect of the present invention, there is provided a document management server comprising:

a memory unit which stores digitized document data in a form of a document describing a predetermined matter over which each of a plurality of users makes a decision, in association with an attribute information thereof;

a supplier which reads the document data specified by each of the plurality of users and the attribute information in association with each other, from the memory unit, and supplies a client device with the read document data and the attribute information, in response to a request for the document data from the client device;

a setting unit which attaches information representing that the document is being updated, to the attribute information associated with the specified document data, in response to a predetermined request from the client device; and

an updating unit which updates the document data and the attribute information, in response to a request for updating the document data from the client device.

In order to accomplish the above objects, according to the fourth aspect of the present invention, there is provided a document passing system including at least one client device and at least one server, wherein:

the at least one server comprises

a memory unit which stores digitized document data in a form of a document describing a predetermined matter over which each of a plurality of users makes a decision, in association with an attribute information thereof,

a supplier which reads the document data specified by each of the plurality of users and the attribute information in association with each other, from the memory unit, and supplies a client device with the read document data and the attribute information, in response to a request for the document data from the client device,

a setting unit which attaches information representing that the document is being updated, to the attribute information associated with the specified document data, in response to a predetermined request from the client device, and

an updating unit which updates the document data and the attribute information, in response to a request for updating the document data from the client device; and

the at least one client device comprises

an acquirer which acquires the digitized document data from the server,

a memory unit which stores the acquired document data,

a display unit which displays the stored document data,

an input unit which accepts a request for inputting a decision result regarding the predetermined matter, from one of the plurality of users,

a determiner which determines whether another one of the plurality of users is editing the document data, upon detection of the request from the one of the plurality of users,

a sender which sends information representing that the decision result can be input and representing contents of the decision result, in a case where it is determined that the another one of the plurality of users is not editing the document data, and

an informer which informs the one of the plurality of users that the decision result can not be input, in a case where it is determined that the another one of the plurality of users is editing the document data.

In order to accomplish the above objects, according to the fifth aspect of the present invention, there is provided a method of controlling updating of a document, comprising the steps of:

acquiring digitized document data in a form of a document describing a predetermined matter over which each of a plurality of users makes a decision, form a server;

storing the acquired document data in a memory unit;

displaying the acquired document data;

accepting a request for inputting a decision result regarding the predetermined matter, from one of the plurality of users;

determining whether there is a priority process for inputting the decision result produced by another one of the plurality of users, upon detection of the request from the one of the plurality of users;

sending information representing that the decision result can be input and representing contents of the decision result, in a case where it is determined that there is a priority process to be executed; and

informing the one of the plurality of users that the decision result can not be input, in a case where it is determined that there is the priority process to be executed.

According to this method, information representing that the decision result can not be input is sent to each of the users, thereby preventing the plurality of users from being in contention for updating the document and unnecessary inputting operations.

In order to accomplish the above objects, according to the sixth aspect of the present invention, there is provided a computer readable recording medium storing a program for controlling a computer to serve as:

an acquirer which acquires digitized document data in a form of a document describing a predetermined matter over which each of a plurality of users makes a decision, from a server;

a memory unit which stores the acquired document data;

a display unit which displays the stored document data;

an input unit which accepts a request for inputting a decision result regarding the predetermined matter, from one of the plurality of users;

a determiner which determines whether there is a priority process, having priority over any other processes, for inputting the decision result produced by another one of the plurality of users, upon detection of the request from the one of the plurality of users;

a sender which sends information representing that the decision result can be input and representing contents of the decision result, in a case where it is determined that there is no priority process; and

an informer which informs the one of the plurality of users that the decision result can not be input, in a case where it is determined that there is the priority process.

According to this recording medium, information representing that the decision result can not be input is sent to each of the users, thereby preventing the plurality of users from being in contention for updating the document and unnecessary inputting operations.

In order to accomplish the above objects, according to the seventh aspect of the present invention, there is provided a computer data signal embedded in a carrier wave representing a program for controlling a computer to serve as:

a control circuit which acquires digitized document data in a form of a document describing a predetermined matter over which each of a plurality of users makes a decision, from a server;

a memory unit which stores the acquired document data;

a control circuit which displays the stored document data;

a control circuit which accepts a request for inputting a decision result regarding the predetermined matter, from one of the plurality of users;

a control circuit which determines whether there is a priority process, having priority over any other processes, for inputting the decision result produced by another one of the plurality of users, upon detection of the request from the one of the plurality of users;

a control circuit which sends information representing that the decision result can be input and representing contents of the decision result, in a case where it is determined that there is no priority process; and

a control circuit which informs the one of the plurality of users that the decision result can not be input, in a case where it is determined that there is the priority process.

According to this computer data signal, information representing that the decision result can not be input is sent to the one of the plurality of users, thereby preventing the plurality of users from being in contention for updating the document and unnecessary inputting operations.

### BRIEF DESCRIPTION OF TIE DRAWINGS

These objects and other objects and advantages of the present invention will become more apparent upon reading of the following detailed description and the accompanying drawings in which:

FIG. 1 is a diagram showing the schematic structure of a document passing system according to an embodiment of the present invention;

FIG. 2 is a block diagram showing the structure of a server included in the system of FIG. 1;

FIG. 3 is a block diagram showing the relationship between databases included in the server of FIG. 2;

FIG. 4 is an exemplary diagram showing a digitized written request for decision and attribute information of the written request, which are stored in the server of FIG. 2;

FIG. 5 is a block diagram showing the structure of a client included in the system of FIG. 1;

FIG. 6 is an exemplary diagram a digitized written request for decision and information to be linked to this written request, in the client of FIG. 5;

FIG. 7 is a flowchart for explaining a process for asking another work section to examine and approve the written request for decision;

FIG. 8 is a diagram showing an example of a page displaying a list of titles of format documents stored in a format-document DB, on the client;

FIG. 9 is a flowchart for explaining a process for asking the head office to examine and approve the written request for decision;

FIG. 10 is a flowchart for explaining a process for examining and approving the written request for decision;

FIGS. 11A and 11B are flowcharts for explaining a document updating process for controlling updating of a predetermined document;

FIG. 12 is a diagram showing an initial page for displaying the written request on the client;

FIG. 13 is a diagram showing an initial page for displaying the written request which has already been edited by a predetermined editor, on the client;

FIG. 14 is a diagram showing an input-denial page representing that any further inputting operations are denied, in the case where an editor has already been set for the written request;

FIG. 15 is a diagram showing an input-denial page representing that any further inputting operations are denied, in the case where the written request has been updated;

FIG. 16 is a diagram showing an example of a page for displaying examination results;

FIG. 17 is a diagram showing an example of a page displayed on a client to which the right to input is given, in the case a plurality of clients request for inputting their decision result; and

FIG. 18 is a diagram showing an example of a page displayed on client to which the right to input is not given, in the case where a plurality of clients request for inputting their decision result.

### DETAILED DESCRIPTION OF THE PREFERRED EMBODIMENT

A preferred embodiment of the present invention will now be described with reference to the accompanying drawings.

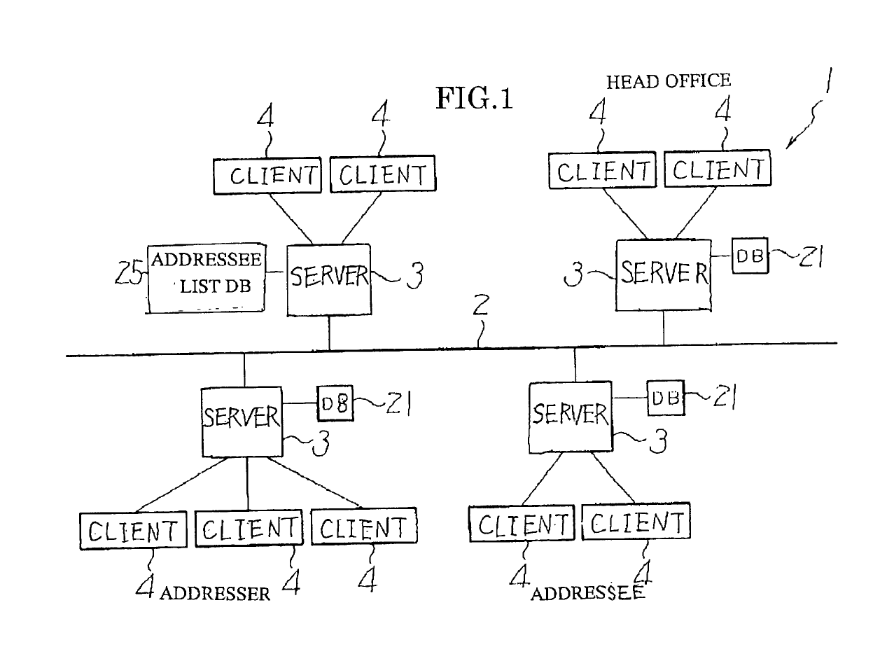

FIG. 1 is a diagram showing the structure of a document passing system 1 according to an embodiment of the present invention. As shown in FIG. 1, the document passing system 1 is a client-server system comprising a plurality of servers 3, a plurality of clients 4 and a network 2. The plurality of servers 3 are connected with each other through the network 2, and each of the plurality of clients 4 is connected to its corresponding server 3. The document passing system 1 is installed in a predetermined organization (e.g., a corporation, a company, etc.), and each of the servers 3 is installed in each section of the organization, for example. A plurality of sections in the organization may commonly share a single server 3.

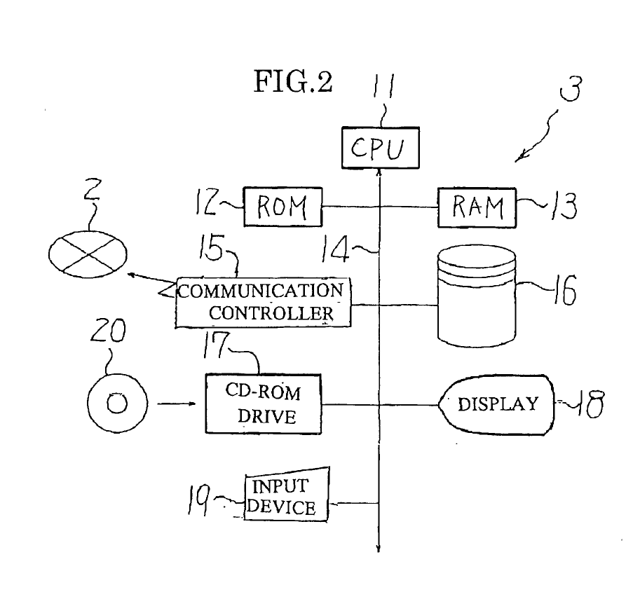

FIG. 2 is a block diagram showing the structure of each server 3 included in the document passing system 1 of FIG. 1. As shown in FIG. 2, the server 3 includes a CPU 11, a ROM 12, and a RAM 13 which are connected with each other through a bus 14. The ROM is a Read-Only Memory storing a BIOS, etc., while the RAM 13 is a rewritable memory storing and rewriting various data and serves as a work area of the CPU 11. In the server 3, a communication controller 15, an HDD (Hard Disk Drive) 16, a CD-ROM drive 17, a display 18, and an input device 19 are connected with each other through the bus 14, or through a non-illustrative interface, etc. The communication controller 15 controls communications to be performed with any other clients 4 or servers 3. The HDD is an external memory unit, which stores various programs and is configured to include a non-illustrative database (DB) 21. The display 18 includes a CRT, LCD, or the like. The input device 19 includes a mouse, a keyboard, etc.

A CD-ROM 20 to be read out by the CD-ROM drive 17 can record various programs thereon. For example, a program for controlling a client-server system to serve as the document updating controller 1 is stored on the CD-ROM 20 and installed in each server 3, thereby causing the client-server system to serve as the document updating controller 1.

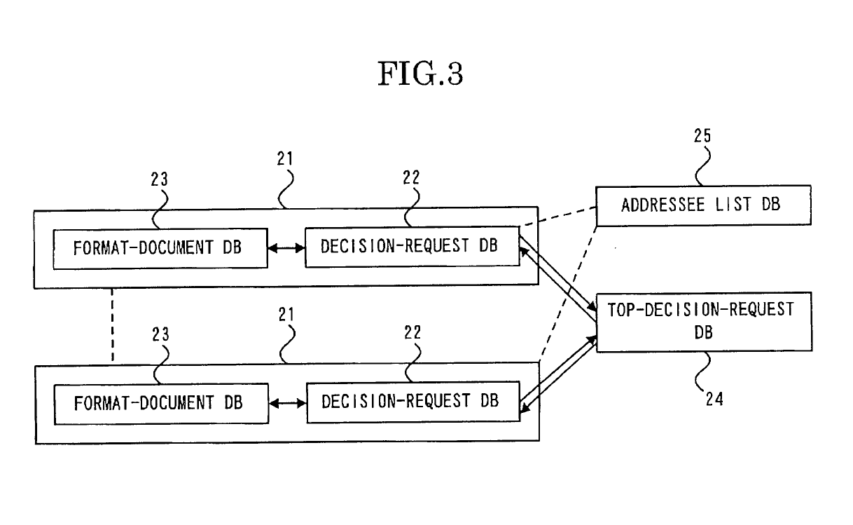

FIG. 3 is a functional block diagram for explaining the relationship between the DBs 21 prepared in the servers 3. As illustrated in FIG. 3, the DB 21 includes a decision-request DB 22 and a format-document DB 23.

The decision-request (a circular to get approval of decision) DB 22 stores written requests for decision to be made by one or more approvers upon examination of a specified matter. The request information is digitized information, and is formed by a person who intends to get approval of decision from the one or more approvers. The request information formed by a predetermined client 4 is stored in the decision-request DB 22 in a server 3 to which this predetermined client 4 is connected. The decision-request DB 22 serves as a reception DB which stores the request information received from another server 3.

The format-document DB 23 stores format documents which are template forms of various documents for creating the written requests for decision. The format-document DB 23 is managed in association with the decision-request DB 22 included in the same server 3.

One of the plurality of servers 3 is arranged in the head office of the organization having this document passing system 1 installed therein. The decision-request DB 22 included in the server 3 of the head office will hereinafter referred to as a top-decision-request DB 24. The top-decision-request DB 24 serves as an e-mail reception DB for receiving a written request for approval of decision to be made by a person who is one of the executives of the organization, for example. This written request is to be sent from the server 3 of each section.

At least one of the plurality of servers 3 includes an addressee list DB 25 (refer to FIG. 1). This addressee list DB 25 stores addressee information representing addressees of each written request for decision to be transmitted in the network 2. That is, the addressee list DB 25 stores information representing: the name of a section in association with each server 3; the name of the decision-request DB 22 to be an e-mail reception DB of each server 3; and the administrator of the decision-request DB 22 of each section. The addressee list DB 25 can be used by each server 3.

Each of the servers 3 includes an examination/approval table which registers information regarding a person who is to approve the written request in the section or head office having the server 3. Specifically, this examination/approval table registers information representing a name of the approver, a section to which the approver belongs, and the approver's e-mail address, etc.

The decision-request DB 22 or top-decision-request DB 24 of each server 3 can resister predetermined registration information in its initialization mode. This registration information includes information representing: the name of each section having each server 3 installed therein; the administrator of the decision-request DB 22; the name of the decision-request DB 22; and the name of the top-decision-request DB 24, etc.

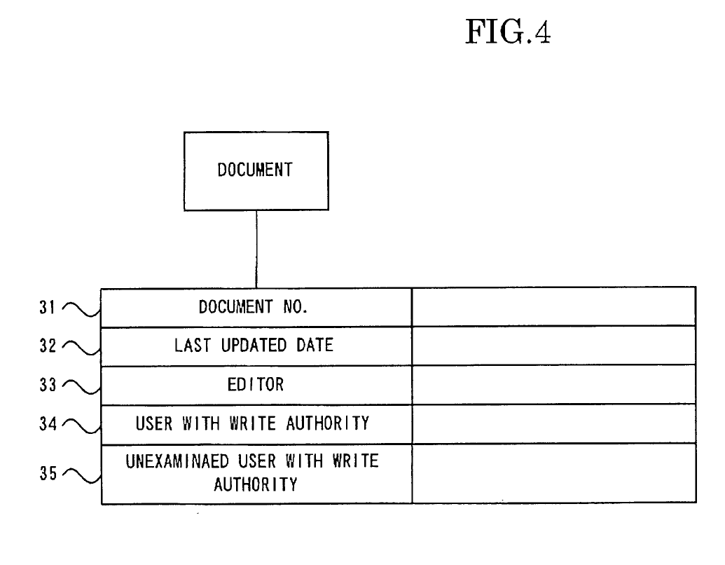

FIG. 4 is an exemplary diagram showing the digitized request information stored in the decision-request DB 22 and attribute information of this request information. As shown in FIG. 4, the attribute information which is linked to the request information includes fields 31 to 35. The field 31 specifies a document number specifying a corresponding written request for decision. The field 32 specifies the last updated date of the written request. The field 33 specifies information representing an editor of a corresponding document. The field 34 specifies a user having write authority. The field 35 specifies a user (an “unexamined user”) corresponding to an unexamined written request and having write authority.

The field 31 specifies the document number as all ID for identifying a corresponding document, and which is automatically or manually given at the time the written request is created. The field 32 specifies date information representing the last updated date which is updated each time the written request is updated, and time information is set based on the clock function of each server 3 or client 4. The field 33 specifies whether there is an editor who currently edits the document. In the case where there is an editor who currently edits the document, the field 33 specifies the current editor. On the contrary, in the case where there is not an editor currently editing the document, the field 33 shows the last editor. Note that this editor is a person who has editing-authority toward the written request, i.e. a person who examines and approves the written request. This person is specified in accordance with the same rule as that of the examination/approval table included in each server 3. The field 34 specifies information representing the person having write authority, i.e. an approver who approves the written request based on the examination. The field 35 specifies user information representing the user specified in the field 34, in association with the written request which has not yet been examined.

Such attribute information can be linked to the written request for decision, using an arbitrary technique. For example, according to one method, the attribute information may be managed as property information of the written request for decision. According to another method, the attribute information is formed independently from the written request for decision, and the attribute information is anchored and linked to the written request for decision.

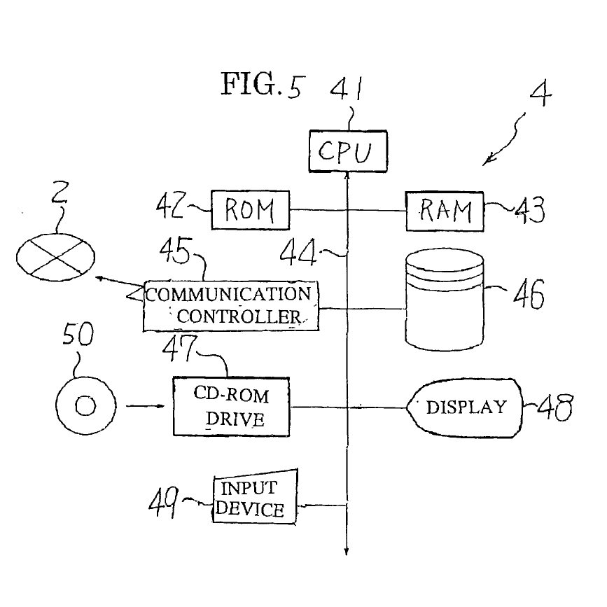

FIG. 5 is a block diagram showing the structure of one of the plurality of clients 4. As shown in FIG. 5, the client 4 comprises a CPU 41, a ROM 42, and a RAM 43 which are connected with each other through a bus 44. The ROM 42 is a Read-Only Memory storing a BIOS, etc., while the RAM 43 is a rewritable memory storing various data and serves as a work area of the CPU 41. As illustrated in FIG. 5, in the client 4, a communication controller 45, an HDD 46, a CD-ROM drive 47, a display 48, and an input device 49 are connected with each other through the bus 44 or through a non-illustrative interface, etc.

A CD-ROM 50 to be read out by the CD-ROM drive 47 can record various programs therein. For example, in the client-server system serving as the document passing system 1, a program for controlling the client to serve as a document updating controller, for controlling an updating process of a predetermined document, is stored in the CD-ROM 50. Further, this program is installed in each client 4. By this, the client-server system can serve as the document passing system 1, while the client 4 can serve as the document passing system.

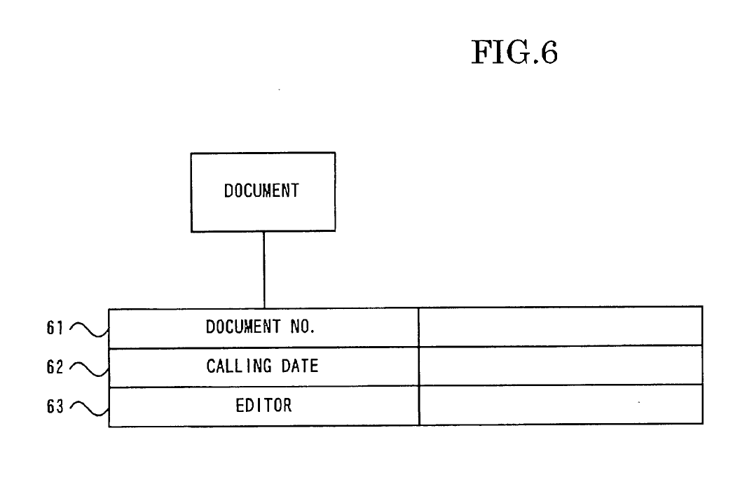

FIG. 6 is an exemplary diagram showing a written request for decision retrieved from the decision-request DB 22 of the server 3 and called by the client 4, in association with attribute information linked to the written request. As shown in FIG. 6, the attribute information linked to the written request includes fields 61 to 63. The field 61 specifies a document number specifying a corresponding written request, the field 62 specifies the date the written request is called, and the field 63 specifics an editor of the written request.

The document number specified in the field 61 is stored in the decision-request DB 22 of the server 3. The same document number as that specified in the field 31 is set in the field 61. That is, the document number specified in the field 61 is number information which can be the ID of the written request. The field 62 specifies date information which is set at the time the written request is called from the decision-request DB 22 by the client 4, and this time information represents the clock information of the client 4. The field 63 specifies the same editor information as that specified in the field 33 included in the attribute information of the written request for decision. The editor information specified in the field 33 expresses an editor at the time the written request is called by the client 4.

Explanations will now be made to a process including procedures, for forming a written request for decision, examining the created written request, approving the examined written request, and sending a written request of the approval to the person who has formed the written request.

(A) Process for Asking Another Work Section to Examine and Approve Written Request for Decision

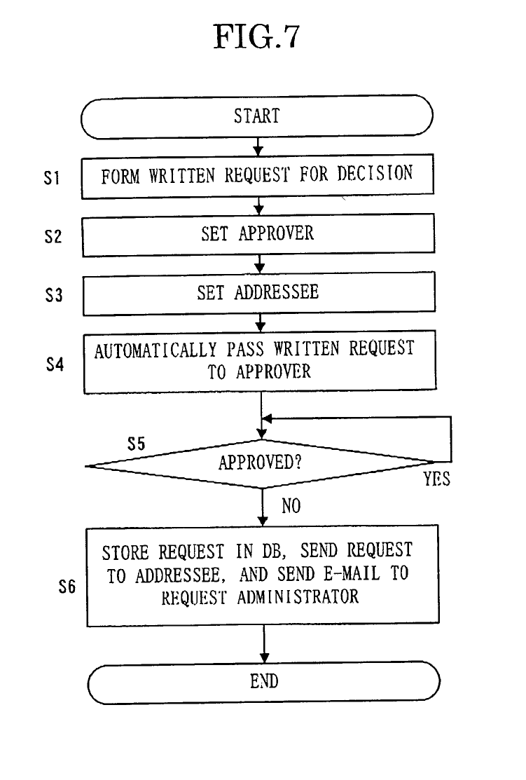

FIG. 7 is a flowchart for explaining a process for asking another section to examine and approve a written request for decision. This flowchart shows both a process executed by the CPU 41 of the client 4 and a process executed by the CPU 11 of the server 3 in accordance with a program for configuring the document passing system 1, in its entirety. In this sense, the flowchart of FIG. 7 schematically explains the entire processing of the document passing system 1, instead of individually describing the processes carried out by the CPU 41 or 11.

If the staff accesses the server 3 from the client 4 installed in the staff's work section, a predetermined page is displayed on the display 48 of the client 4. Upon clicking on a button included in this page, the page can be initially set or the written request for decision can be formed.

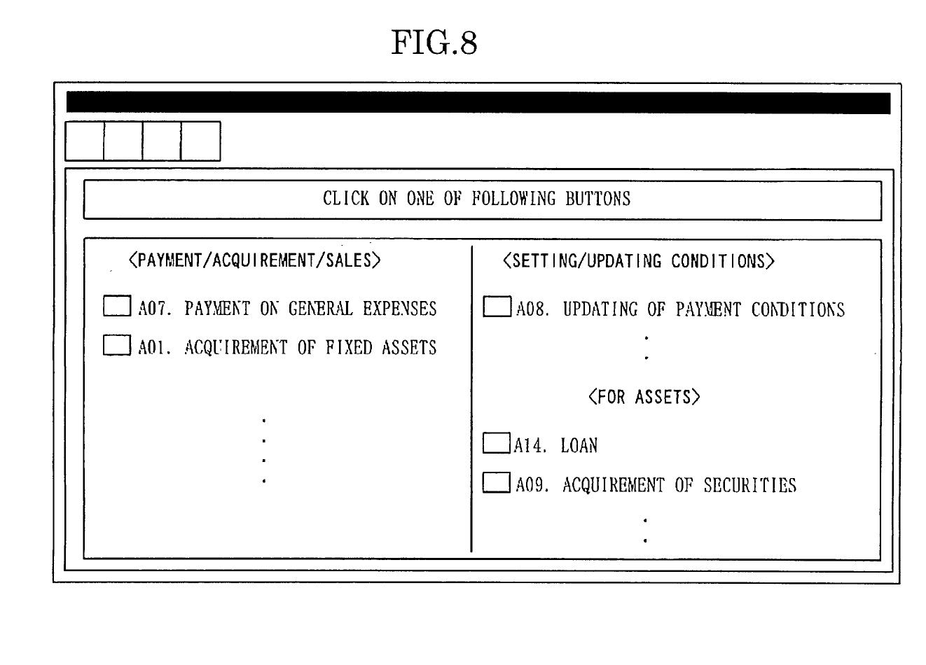

If the staff clicks on a button for forming a written request for decision (for making a decision on a predetermined matter) on this page, the written request can be formed (Step S1 In this case, a page shown in FIG. 8 can be displayed on the client 4. The page of FIG. 8 shows a list of titles of format documents stored in the format-document DB 23. Specifically, the list may include “Payment of General Expenses”, “Acquirement of Fixed Assets”, etc. Note that, in the example of FIG. 8, various programs read from the CD-ROM 20 are the application software running on the Windows (Microsoft Corporation). By this, means for and a step of displaying a corresponding title can be realized. An item button 71 is attached on the head of each title of the format page. If the item button 71 is clicked, its corresponding format document can be selected. Upon selection of the item button 71, the selected format document is read out from the format-document DB 23, and the read document is set as a template for forming a written request for decision, and the format document is displayed on the display.

The written request for decision is formed in such a way that a title or body part of the document is filled in the selected template. In thus formed written request, registration information registered in the decision-request DB 22 in the above-described initial setting is automatically written.

In this manner, after the written request for decision is formed in the step S1, the approver of the written request for decision is set (Step S2). That is, in the step, a person who will digitally sign (approve) the formed written request for decision will be selected. In this case, the selection is made from a plurality of persons are registered in an approver table prepared in advance in the decision-request DB 22.

After the approver is selected (Step S2), the addressee of the written request is set (Step S3). In this case, a predetermined addressee is selected from the addressee list DB 25.

Upon setting of the addressee (Step S3), the written request for decision is automatically passed to the approver (Step S4). That is, an e-mail, representing that there is the written request for decision to be approved, is sent to the approver. Upon reception of this e-mail, the approver opens the decision-request DB 22, views the corresponding written request for decision, and digitally signs or approves the written request (Step S5; Yes). Then, the approved written request is sent to the decision-request DB 22 of the addressee section in the organization. In addition, an e-mail representing that the written request has been sent is sent to the administrator of the decision-request DB 22 of the addressee section, and the written request is stored in the decision-request DB 22 of the section to which the creator of this written request belongs (Step S6), and the process of FIG. 7 is completed.

(B) Process for Asking Head Office to Examine and Approve Written Request for Decision

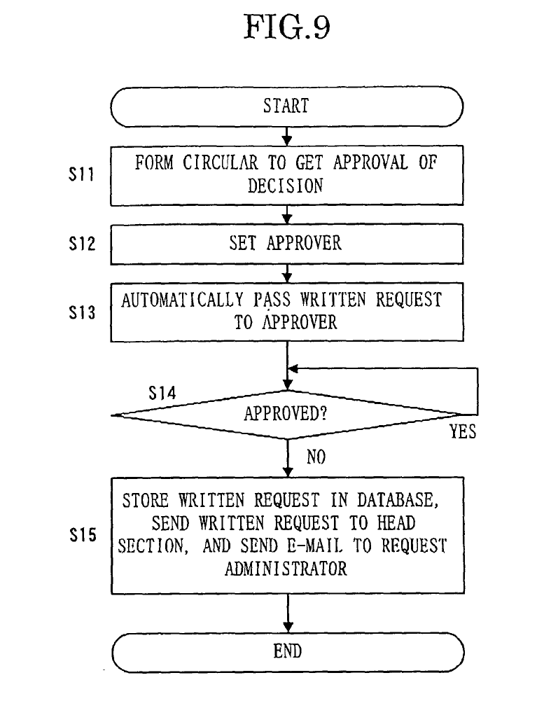

FIG. 9 is a flowchart for explaining a process for asking the head office to examine and approve the written request for decision. This flowchart shows both a process executed by the CPU 41 of the client 4 and a process executed by the CPU 11 of the server 3 in accordance with a program for configuring the document passing system 1, in its entirety. In this sense, the flowchart of FIG. 9 schematically explains the entire processing of the document passing system 1, instead of individually describing the processes carried out by the CPU 41 or 11.

If the staff forms the written request (a circular to get approval of decision) to be sent to the head office in accordance with the same procedure as that of the step S1 (Step S11), the approver is selected in accordance with the same procedure as that of the step S2 (Step S12). In this case, the formed written request (a circular to get approval of decision) is set in advance so as to be sent to the head office. Hence, it is not necessary to set the addressee unlike the step S3, and the written request is automatically passed to the approver likewise the step S4 (Step S13). After the approver signs or approves the written request (Step S14; Yes), the written request (a circular to get approval of decision) is sent to the top-decision-request DB 24. Then, an e-mail representing the transmission of the written request is sent to the administrator of the decision-request DB 22 of the head office, and the written request for decision is stored in the decision-request DB 22 of the section to which the written request creator belongs (Step S15), and this process is completed.

In the case where the staff asks his/her work section to examine and approve the written request for decision, the same procedures as those of the steps S1 to S6 are executed. However, in this case, the procedure (the step S3) for setting the addressee is not necessary. Further, the written request for decision after approved is simply stored in the decision-request DB 22 of the section to which the written request creator belongs. Then, an e-mail representing that the written request for decision is stored in the decision-request DB 22 is sent to the administrator of the staff's work section.

(C) Process for Examining and Approving Written Request for Decision

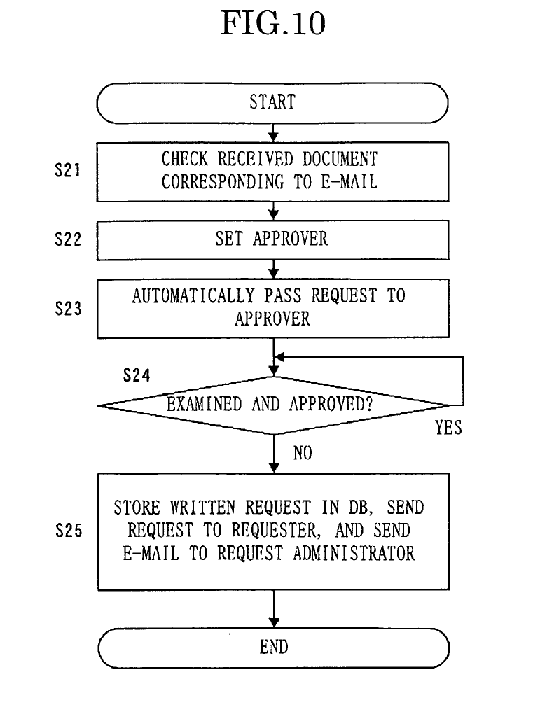

FIG. 10 is a flowchart for explaining a process for examining and approving a written request for decision sent from another work section in the organization. This flowchart shows both a process executed by the CPU 41 of the client 4 and a process executed by the CPU 11 of the server 3 in accordance with a program for configuring the document passing system 1, in its entirety. In this sense, the flowchart of FIG. 10 schematically explains the entire processing of the document passing system 1, instead of individually describing the processes carried out by the CPU 41 or 11.

In the case where the administrator of the decision-request DB 22 opens this database and receives an e-mail representing that the written request has been sent from another work section in the organization (Step S21), the administrator selects and sets a desired person from those registered in the examination/approval table prepared in the server 3 of the administrator (Step S22), as an approver who will be examining and approving the written request. After this, the written request is automatically passed to the examiner/approver (Step S23). That is, an e-mail representing that a written request to be examined and approved is automatically given to the set approver, i.e. an e-mail address registered in the examination/approval table is automatically set. This e-mail expresses that the written request for decision is transmitted, and includes an anchored object to be linked to this written request.

The client 4 can display a list of titles of received e-mails, on the display 48. Upon reception of an e-mail representing that the written request for decision is transmitted, the client 4 displays a sign (e.g. “+++”) for distinguishing this kind of e-mail from any other kinds of e-mails, in the head part of the e-mail title.

The user accesses the decision-request DB 22 from the client 4, opens an e-mail having the above sign attached to this e-mail, an clicks on the anchored object to be linked to the written request. Upon this, the corresponding written request is read out from the decision-request DB 22, and stored in the RAM 43 serving as a memory area of the client 4. In this manner, means (step) for reading the written request for an input of the determination result from the server 3 and for storing the read written request in a memory area (the RAM 43) can be realized. With this means, the user can view the written request for decision displayed on the display 48 of the client 4, and attaches a decision result regarding the written request thereto, so as to successfully input information representing the examination and approval of the written request (Step S24; Yes). By this, means (a step) for displaying the written request for decision on the display 48 can be realized, so that the user can input the request for inputting the decision result through the client 4.

The written request for decision after examined and approved (Step S24; Yes) is automatically sent to the decision-request DB 22 of the work section having requested the examination and approval of the written request. In this case, the addressee of the written request to be sent is determined based on the registration information written in the written request for decision. An e-mail representing that the examination and approval of the written request have been made is automatically sent to the administrator of the decision-request DB 22. In this case, the addressee of the e-mail to be sent is determined based on the registration information written in the written request for decision. The written request after examined and approved is stored also in the decision-request DB 22 of the section having examined and approved the written request (Step S25). The administrator of the decision-request DB 22 who has received the above e-mail executes simply a predetermined operation, thereby sending the e-mail representing that the examination and approval have been made to the staff who has formed the written request for decision. Note that information representing the e-mail address of this staff is written in advance in the written request for decision.

In the head office, in the case where the written request for decision is received from another work section, the same procedures as the steps S21 to S25 are carried out. Even in the case where the written request for decision has been transmitted within the same work section, the procedures of the steps S21 to S25 are carried out, the e-mail representing that the examination and approval have been completed is sent to the administrator of the same work section, in the step S25.

(D) Document Updating Controlling Process

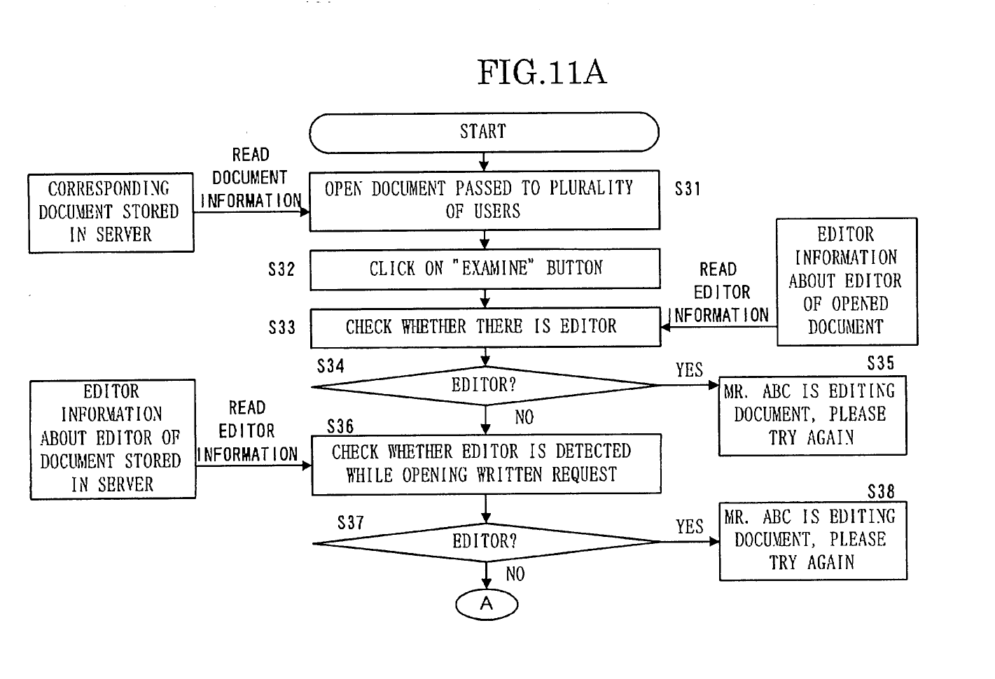

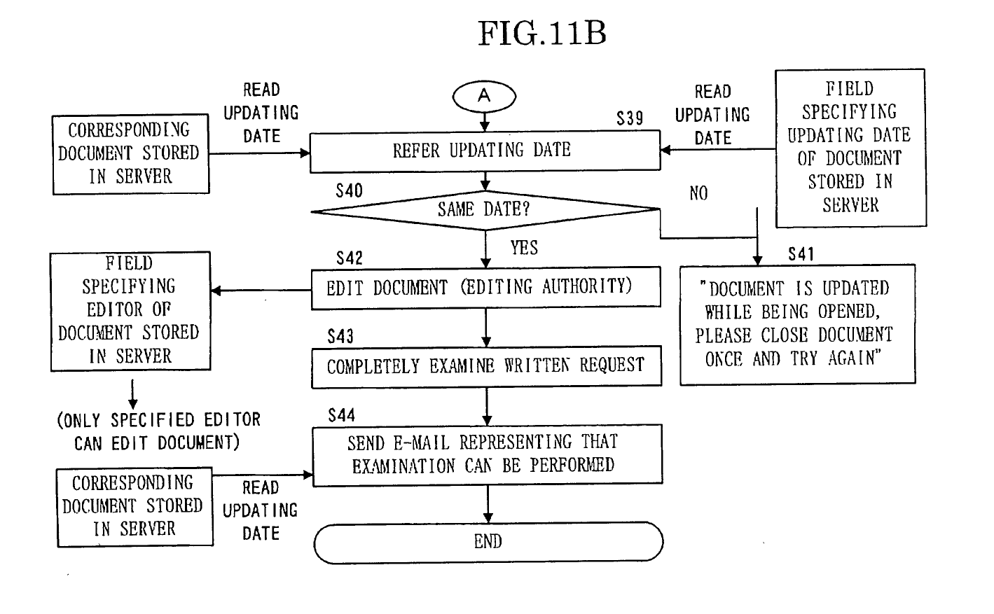

The same written request for decision is opened at the same time by a plurality of clients 4 in the steps S4 and S5 of FIG. 7, in the steps S13 and S14 of FIG. 9, and also in the steps S23 and S24 of FIG. 10. Then, the opened written request may possibly be approved by the plurality of clients 4 at the same time. In consideration of this, the exclusive control of the written request should be executed. That is, in the case where the same written request is opened by the plurality of clients 4 and one of the plurality of clients 4 sends an instruction for updating (approving, etc.) the written request, the rest of the plurality of clients 4 are prohibited from updating the written request. At this time, in this embodiment, a document updating controlling process shown in FIGS. 11A and 11B will be executed in accordance with a predetermined program installed in each client 4.

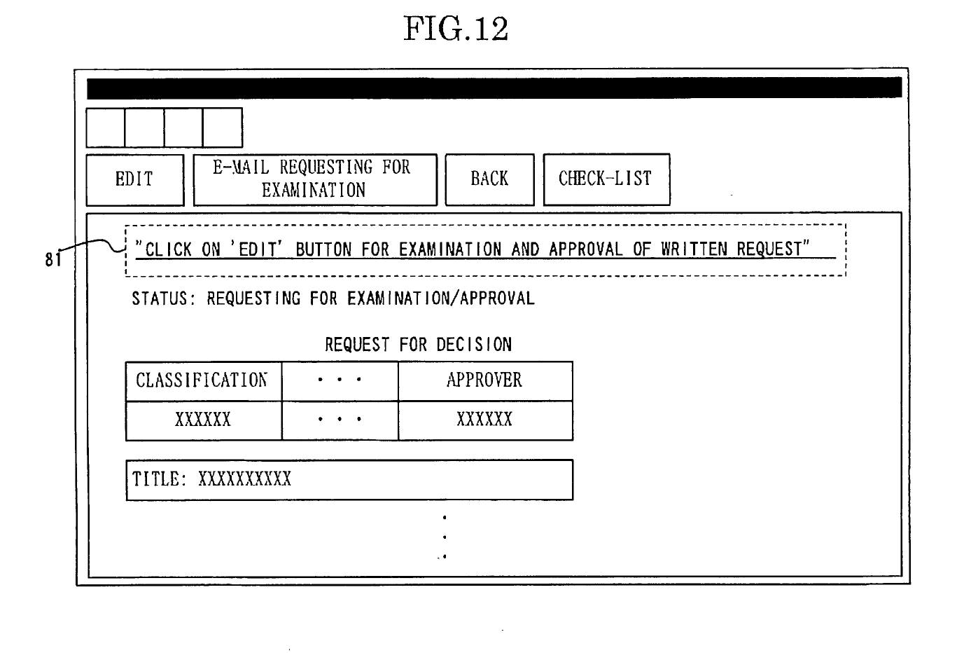

The document updating controlling process will now be described with reference to pages shown FIGS. 12 to 18 and displayed on the display 48 of the client 4.

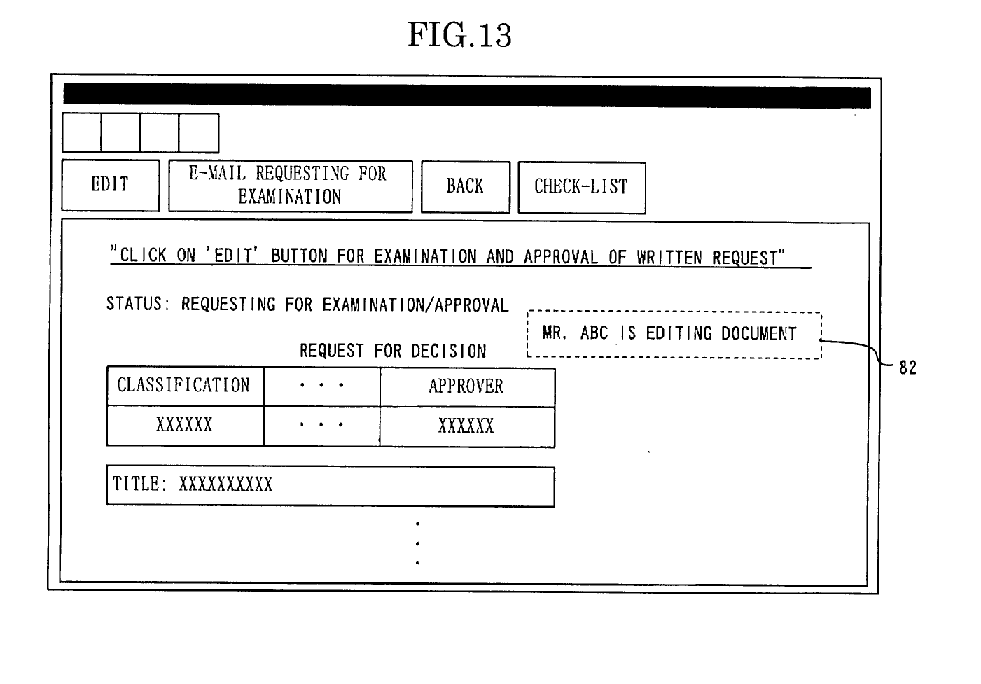

The document updating controlling process shown in FIG. 11 has detail procedures to be executed between the steps S23 and S24 of FIG. 10. In the case where the client 4 opens the written request for decision in the form of a digitized document (Step S31), the display 48 of the client 4 displays the specified written request for decision. Each of FIGS. 12 and 13 shows an example of an initial page of the specified written request.

The specified written request is sent from the decision-request DB 22 managed by the server 3. At this time, the editor information specified in the field 33, as attribute information of the written request, is also sent to the client 4. Upon reception of the written request, the client 4 sets the editor information as the attribute information of the written request, in the field 63 to be linked to the written request. The information set in the field 63 corresponds to the information specified in the field 61 specifying the document number of the written request. The information set in the field 61 further corresponds to the date information specified in the field 62.

The editor information specified in the field 63 provides information materials, for determining whether a client 4 is currently editing a written request for decision at the time another client 4 just opens this written request. In this embodiment, the editor information specified in the field 63 is necessary for executing a process for displaying the initial page showing the written request for decision.

FIG. 12 shows an initial page of the currently-opened written request to be displayed on the display 48, in the case where a Null value is set in the field 33 of the decision-request DB 22 managed by the server 3 and no information is set in the field 63.

FIG. 13 shows an initial page of the currently-opened written request to be displayed on the display 48, in the case where editor information is set in the field 33 of the decision-request DB 22 managed by the server 3 and the editor information is set also in the field 63.

In both pages shown in FIGS. 12 and 13, an examination object 81 “Click on ‘Edit’ button for examination and approval of written request” is shown. Only in the page shown in FIG. 13, a message 82 “Mr. ABC is now editing the document” is displayed. In the case where there is a predetermined priority process having priority over any other processes, means (a step) for informing that a decision result can not be input in response to the written request therefor is realized, before inputting the decision result upon examination and approval of the written request. Note that the priority process includes a process to be executed prior to the inputting process for inputting the decision result. This priority process may include a process to be executed by the editor in the case where the editor has already been set for the same document after the written request for inputting the decision result is issued. Further, the priority process may include an updating process for updating the document performed since the document is opened until the request for inputting the decision result is issued.

Note that the examination object 81 is prepared for requesting an input of the decision result, for examination and approval of written request. If this examination object 81 is selected, a command for requesting an input of the decision result can be executed.

Upon selection of the examination object 81 (Step S32), it is checked whether there is the editor information in the field 63, i.e. it is checked whether there is the priority process to be executed (Step S33). This checking performed based on the information set in the field 63 which is stored in the RAM 43 of the client 4. That is, the client 4 determines whether there is another client device 4 which is currently editing the opened written request for decision, through self-checking (Step S34). By this, in the case where there is issued the written request for the decision result, there is realized means (a step) for determining whether there is a priority process for processing the decision result produced by another client 4.

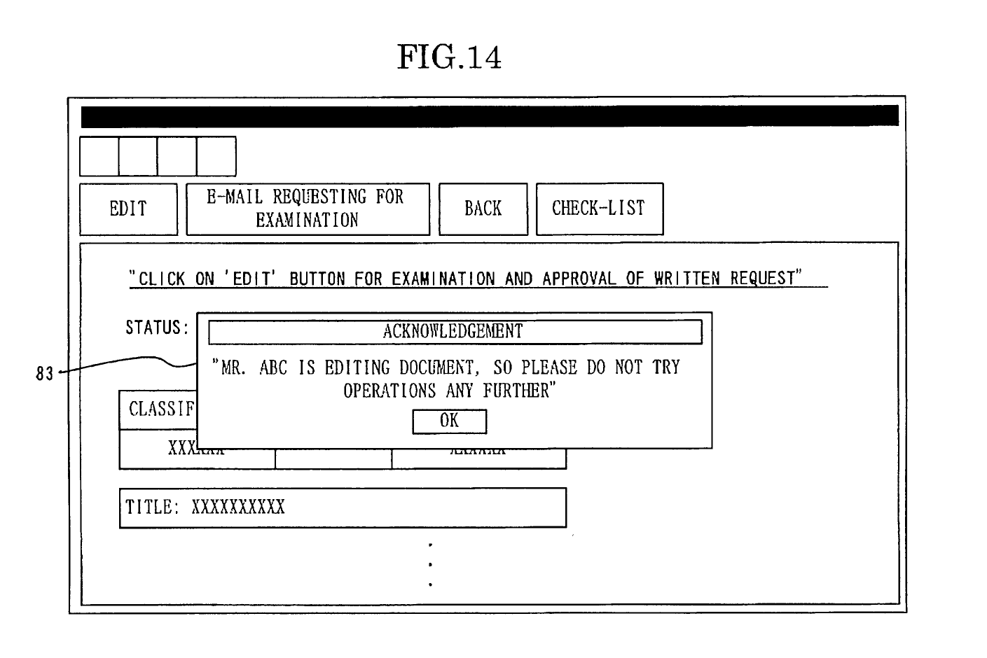

As a result of the above determination, in the case where it is determined that there is the editor who is currently editing the opened written request, this determination result is issued to the user of the client 4 (Step S35). In the case where there it is determined that there is the priority process to be carried out, there is processed means (a step) for informing the user that the written request for the decision result can not successfully be realized, prior to the inputting of the decision result. In this case, as shown in the flowchart of FIG. 11, a message “Mr. ABC is editing the written request, so please try again” may be displayed. In the above case, as shown in the flowchart of FIG. 14, a message “Mr. ABC is editing the written request, so please do not try operations any further” may be displayed.

As shown in FIG. 13, the page may show a message “Mr. ABC is editing the written request” as reporting information. Even though such a message is displayed, if the examination object 81 is selected, further messages will be displayed. Such messages may be “Mr. ABC is editing the written request, so please try again” and “Mr. ABC is editing the written request, so please do not try operations any further”. That is, those messages represent that the written request for the decision result can not successfully be achieved.

In the case where it is determined that there is no another client 4 which is currently editing the written request through self-checking in the step S34, the client 4 now instructs the server 3 to determine whether another client 4 is currently editing the written request (Step S36). In this case, the server 3 refers to the field 333 specifying the attribute information of the written request for decision, and sends the referring result to the client 4.

The client 4 receives the referring result from the server 3, and determines whether there is another client 4 which is currently editing the currently-opened written request (Step S37). In the case where there is issued a written request for decision, there is realized means (a step) for determining whether there is a priority process for processing the decision result produced by another client 4 (another user).

In the case where it is determined that there is the editor who is currently editing the written request, the client 4 reports about this to the user (Step S38). In the case where it is determined that there is the priority process to be carried out, there is realized reporting means (a step) for reporting that the request for inputting the decision result can not be realized, prior to the inputting of the decision result. This reporting may be achieved by displaying a message “Mr. ABC is editing the written request, so please try again later”, as shown in the flowchart of FIG. 11. Another message may be “Mr. ABC is editing the written request, so please do not try operations any further”, as shown in an acknowledgement-dialogue 83 of FIG. 14.

In the case where it is determined that there is no editor in the step S37, the client 4 checks whether a written request for decision is updated by another client 4 while the written request is being opened (Step S39). This checking is realized by an inquiry process between the server 3 and the client 4. That is, the server 3 refers to the field 32 specifying the last updated data, as the attribute information of the written request, and sends a referring result to the client 4. The client 4 refers to the field 62 specifying the date the written request is called, and compares the information of the field 62 with the referring result sent from the server 3. If the last update date and the called date are the same date, it means that the written request is not being updated since then. The client 4 refers to the last updated date sent from the server 3 with the called date stored in the RAM 43, and determines whether the opened written request is updated since then (Step S40). By this, there can be realized means (a step) for determining whether there is a priority process for inputting the decision result made by a predetermined client 4, in the case where there is issued a request for inputting the decision made by another client 4, i.e. whether the same written request is edited by another client 4.

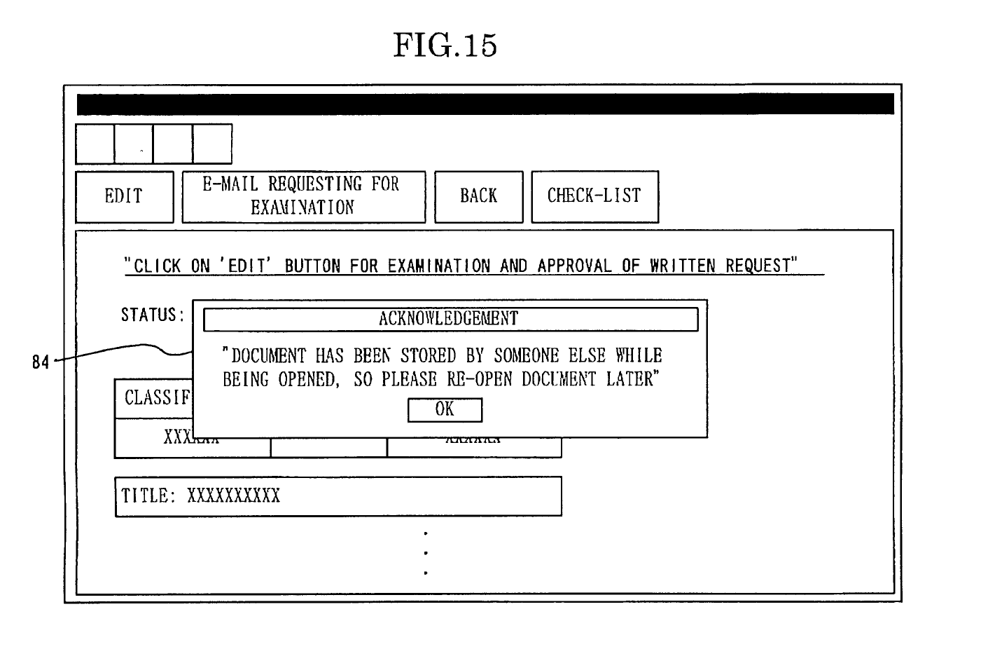

In the case where it is determined that the currently-opened request is updated by another client, the client reports this to the user (Step S1). In the case where there is the priority process, there can be realized means (a step) for reporting that the request for inputting the decision result can not be realized, prior to the inputting of the decision result. In this case, as shown in the flowchart of FIG. 11, a message “Document has been updated while being opened, please close the document once, and try again” may be displayed. Another message “Document has been stored by someone else while being opened, so please re-open the document” may be displayed as well in an acknowledgement dialogue 84, as shown in FIG. 15.

In the case where it is determined that the opened written request for decision is not updated in the step S40, a process for automatically editing the written request is carried out (Step S42). In this process, the server 3 is requested to set a user of the client 4, in the field 33 specifying the editor of the corresponding written request.

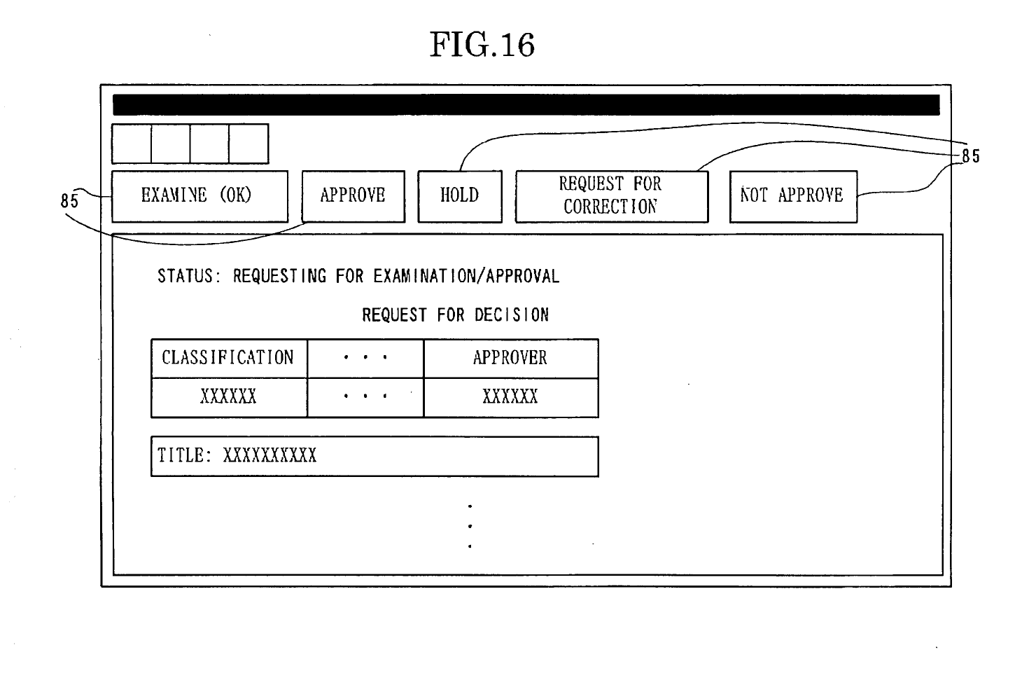

Now, an examination process for examining the written request can be executed in this embodiment (Step S43). At this time, the display 48 of the client 4 displays five examination-result objects 85, “Examine (OK)”, “Approve”, “Hold”, “Request For Correction”, and “Not Approve”, as shown in FIG. 16. In the case where the user selects a predetermined object of the five examination-result objects 85, information representing the selected object is sent to the server 3, thereby completing the examination of the written request. In the case where it is determined that there is no priority process to be executed, there can be realized means (a step) for inputting the decision result and for executing the process for sending the input decision result to the server 3.

After this, the client 4 requests the server 3 to send information specified in the field 35 and representing an unexamined user having write authority, to send an e-mail for informing the unexamined user that the examination can now be performed (Step S44). The client 4 receives the field information from the server 3, and sends the e-mail to the unexamined user. The server 3 refers to the field 35 to find out the examined user.

The plurality of clients 4 may specify the same examination object 81 almost at the same time in the step S32. In this case, the server 3 gives editing authority to one of the plurality of clients 4 that has specified the examination object 81 first, based on the time information sent from the clients 4 or the time information obtained by the server 3 itself.

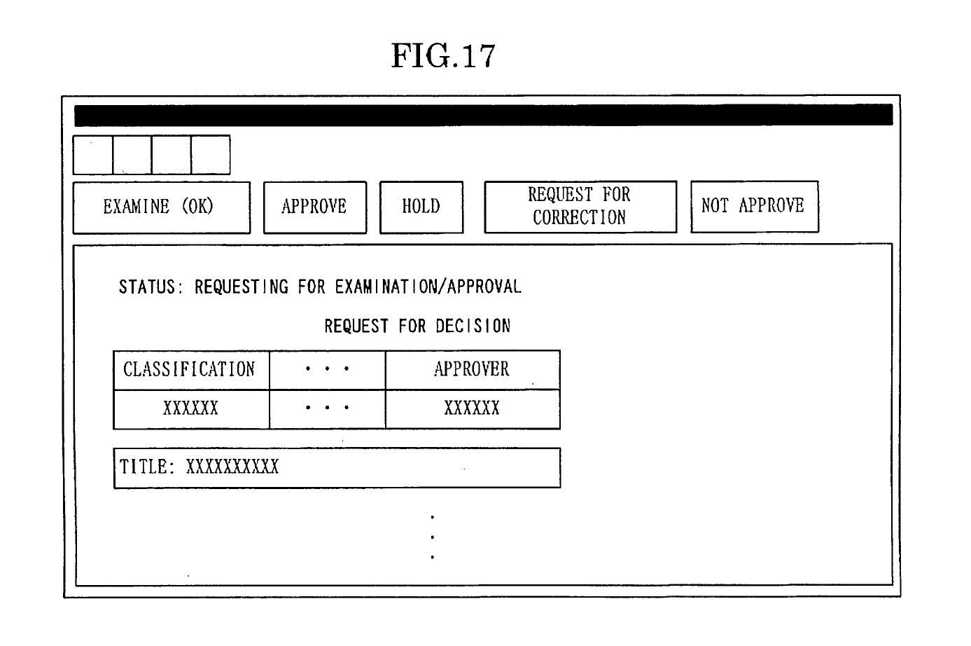

FIG. 17 illustrates a page to be displayed on the display 48 of the client 4 having the editing authority in the above case.

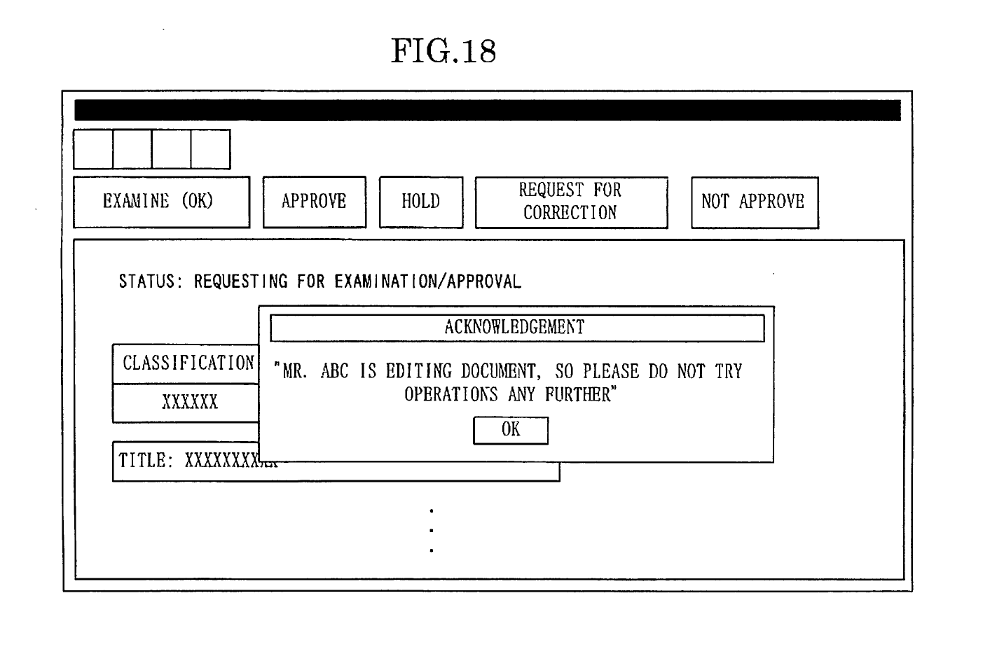

FIG. 18 illustrates a page to be displayed on the display 48 of the client 4 having no editing authority in the above case.

The explanations have been made to the preferred embodiment of the present invention. The system of the present invention can be realized by a general computer, without the need for a dedicated system. A program and data for controlling a computer to execute the above-described processes may be recorded on a medium (a floppy disk, CD-ROM, DVD or the like) and distributed, and the program may be installed into the computer and run on an OS (Operating System) to execute the above-described processes, thereby achieving the server 3 included in system of the present invention.

The above program and data may be posted on a BBS (Bulletin Board System) of a communication network, and may be embedded in a carrier wave so as to be distributed through a communication line. The program and data embedded in the carrier wave may be downloaded into computers so as to realize the system of the present invention.

The program is activated, and executed under the control of the OS likewise other application programs, so as to execute the above processes.

In the case where the OS is to execute a part of the above processes, or in the case where the OS is one of the component elements of the system of the present invention, a program excluding the part of the above processes may be stored on a recording medium. In such a case, the recording medium stores a program for executing each function or step to be carried out by the computer, thereon.

In the above-described document updating controlling process, it is determined whether a target document to be processed is being edited by another client 4 or whether a target document to be processed is updated by a client 4 while the document is opened by another client 4. In this case, the client 4 acquires the editor information specified in the field 33 or date information representing the date the document is updated, from the server 3, and performs the determination based on the acquired information. However, the information to be sent from the server 3 is not limited to this, and may include various status information representing whether the document is being edited or representing whether the document opened on a predetermined client 4 is updated by another client 4. The client 4 determines whether the target document to be processed is being edited by another client 4 or has been updated by another client 4, based on the status information sent from the server 3.

As explained above, according to the present invention, it is informed that a request for inputting the decision result can not be realized, thereby preventing the contention of a plurality of documents and preventing unnecessary inputting operations.

The client 4 can acquire information representing whether there is a priority process for processing the written request for decision, i.e. whether there is another editor to be editing the request, from the server 3.

The client 4 acquires status information representing whether the decision result is being input by another client 4, from the server 3, thereby easily determining whether there is a priority process to be executed.

For the document being processed, the client 4 acquires editor information regarding the editor of the document (e.g. information representing whether there is a user currently editing the document), thereby easily determining whether there is a priority process to be executed.

The client 4 acquires status information representing that the decision result is input by another client 4 from the server 3, thereby easily determining whether there is a priority process to be executed.

In the case where the calling date of the document stored in a memory area of the client 4 is not the same as the updating date of the document received from the server 3, it can be understood that the decision result is input by another client 4, thereby easily determining whether there is a priority process to be executed.

When calling a document from the server 3, the client 4 receives data regarding the priority process together with the document, and stores the received data with the document in the memory area. After this, the client 4 refers to the data stored in the memory area, and executes a process for determining whether there is the priority process. Hence, the client 4 can easily acquire information representing whether there is the priority process to be executed, without inquiring of the server 3 about that. Therefore, the system of the present invention can easily determine whether there is a priority process to be executed, without giving the processes onto the network.

Various embodiments and changes may be made thereonto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2001-271854 filed on Sep. 7, 2001, and including specification, claims, drawings and summary. The disclosure of the above Japanese Patent Application is incorporated herein by reference in its entirety.

What is claimed is:

1. A document updating controller comprising:
an acquirer which acquires digitized document data in a form of a document describing a predetermined matter over which each of a plurality of users makes a decision, from a server;
a memory unit which stores the acquired document data;
a display unit which displays the stored document data;
an input unit which accepts a request for inputting a decision result regarding the predetermined matter, from one of said plurality of users;
a determiner which determines whether there is a priority process, having priority over any other processes, for inputting the decision result produced by another one of said plurality of users so as to update the document data, upon detection of the request from said one of said plurality of users;
a sender which sends information representing that the decision result can be input and representing contents of the decision result, in a case where it is determined that there is no priority process; and
an informer which informs the one of said plurality of users that the decision result can not be input, in a case where it is determined that there is the priority process.

2. The document updating controller according to claim 1, wherein
said determiner determines whether there is the priority process to be executed, by inquiring of said server whether there is the priority process to be executed.

3. The document updating controller according to claim 2, wherein
said determiner determines that there is the priority process to be processed, in a case where said determiner receives, from said server, status information representing that the another one of said plurality of users is inputting the decision result.

4. The document updating controller according to claim 3, wherein
the status information includes information regarding an editor of the document.

5. The document updating controller according to claim 2, wherein
said determiner determines that there is the priority process, in a case where said determiner receives status information representing that the decision result has been input within a predetermined period of time, from said server.

6. The document updating controller according to claim 5, wherein:
the status information includes date information representing an updating date the document is updated; and
said determiner determines that there is the priority process to be executed, in a case where the updating date is not same as a calling date the document is called from said server.

7. The document updating controller according to claim 1, wherein:
said acquirer acquires data regarding the priority process, together with the document data;
said memory unit stores the data regarding the priority process in association with the document data; and
said determiner refers to the data regarding the priority process and stored in said memory unit, and determines whether there is the priority process to be executed.

8. A client device comprising:
an acquirer which acquires digitized document data in a form of a document describing a predetermined matter over which each of a plurality of users makes a decision, from a server;
a memory unit which stores the acquired document data;
a display unit which displays the stored document data;
an input unit which accepts a request for inputting a decision result regarding the predetermined matter, from one of said plurality of users;
a determiner which determines whether another one of said plurality of users is editing the document data so as to update the document data, upon detection of the request from said one of said plurality of users;
a sender which sends information representing that the decision result can be input and representing contents of the decision result, in a case where it is determined the another one of said plurality of users is not editing the document data; and
an informer which informs the one of the plurality of users that the decision result can not be input, in a case where it is determined that the another one of said plurality of users is editing the document data.

9. A document management server comprising:
a memory unit which stores digitized document data in a form of a document describing a predetermined matter over which each of a plurality of users makes a decision, in association with attribute information thereof;
a supplier which reads the document data specified by each of the plurality of users and the attribute information in association with each other, from said memory unit, and supplies a client device with the read document data and the attribute information, in response to a request for the document data from said client device;
a setting unit which attaches information representing that the document is being updated, to the attribute information associated with the specified document data, in response to a predetermined request from the client device; and
an updating unit which updates the document data and the attribute information, in response to a request for updating the document data from the client device.

10. A document passing system including at least one client device and at least one server, wherein:
said at least one server comprises
a memory unit which stores digitized document data in a form of a document describing a predetermined matter over which each of a plurality of users makes a decision, in association with attribute information thereof,
a supplier which reads the document data specified by each of the plurality of users and the attribute information in association with each other, from said memory unit, and supplies a client device with the read document data and the attribute information, in response to a request for the document data from said client device,
a setting unit which attaches information representing that the document is being updated, to the attribute information associated with the specified document data, in response to a predetermined request from the client device, and
an updating unit which updates the document data and the attribute information, in response to a request for updating the document data from the client device; and
said at least one client device comprises
an acquirer which acquires the digitized document data from said server,
a memory unit which stores the acquired document data,
a display unit which displays the stored document data,
an input unit which accepts a request for inputting a decision result regarding the predetermined matter, from one of said plurality of users,
a determiner which determines whether another one of said plurality of users is editing the document data so as to update the document, upon detection of the request from said one of said plurality of users,
a sender which sends information representing that the decision result can be input and representing contents of the decision result, in a case where it is determined that the another one of said plurality of users is not editing the document data, and
an informer which informs the one of the plurality of users that the decision result can not be input, in a case where it is determined that the another one of said plurality of users is editing the document data.

11. A method of controlling updating of a document, comprising the steps of:
acquiring digitized document data in a form of a document describing a predetermined matter over which each of a plurality of users makes a decision, form a server;
storing the acquired document data in a memory unit;
displaying the acquired document data;
accepting a request for inputting a decision result regarding the predetermined matter, from one of the plurality of users;
determining whether there is a priority process for inputting the decision result produced by another one of the plurality of users so as to update the document data, upon detection of the request from the one of the plurality of users;
sending information representing that the decision result can be input and representing contents of the decision result, in a case where it is determined that there is a priority process to be executed; and
informing the one of the plurality of users that the decision result can not be input, in a case where it is determined that there is the priority process to be executed.

12. A computer readable recording medium storing a program for controlling a computer to serve as:
an acquirer which acquires digitized document data in a form of a document describing a predetermined matter over which each of a plurality of users makes a decision, from a server;
a memory unit which stores the acquired document data;
a display unit which displays the stored document data;
an input unit which accepts a request for inputting a decision result regarding the predetermined matter, from one of said plurality of users;
a determiner which determines whether there is a priority process, having priority over any other processes so as to update the document data, for inputting the decision result produced by another one of said plurality of users, upon detection of the request from said one of said plurality of users;
a sender which sends information representing that the decision result can be input and representing contents of the decision result, in a case where it is determined that there is no priority process; and
an informer which informs the one of said plurality of users that the decision result can not be input, in a case where it is determined that there is the priority process.

13. A computer data signal embedded in a carrier wave representing a program for controlling a computer to serve as:
a control circuit which acquires digitized document data in a form of a document describing a predetermined matter over which each of a plurality of users makes a decision, from a server;
a memory unit which stores the acquired document data;
a control circuit which displays the stored document data;
a control circuit which accepts a request for inputting a decision result regarding the predetermined matter, from one of said plurality of users;
a control circuit which determines whether there is a priority process, having priority over any other processes, for inputting the decision result produced by another one of said plurality of users so as to update the document data, upon detection of the request from said one of said plurality of users;
a control circuit which sends information representing that the decision result can be input and representing contents of the decision result, in a case where it is determined that there is no priority process; and
a control circuit which informs the one of said plurality of users that the decision result can not be input, in a case where it is determined that there is the priority process.
